(19) United States
(12) Patent Application Publication
(10) Pub. No.: US 2022/0270367 A1
(43) Pub. Date: Aug. 25, 2022

(54) METHOD AND DEVICE FOR AUTOMATICALLY RECOGNIZING SPORT COURT AND DETERMINING IN/OUT ON BASIS OF SAME

(71) Applicant: DIBL CO., LTD., Gyeonggi-do (KR)

(72) Inventors: Chang Man PARK, Gyeonggi-do (KR); Kiwon YEOM, Gyeongsangnam-do (KR); Jonghyon RYU, Gyeonggi-do (KR); Howon JEONG, Gyeongsangbuk-do (KR)

(21) Appl. No.: 17/442,256

(22) PCT Filed: Mar. 24, 2019
(86) PCT No.: PCT/KR2019/003410

§ 371 Date: May 11, 2022

(51) Int. Cl. G06V 20/40; G06T 7/13; G06T 7/70; A63B 71/04; A63B 71/06

(52) U.S. Cl. CPC G06V 20/42; G06T 7/13; G06T 7/70; A63B 71/04; A63B 71/0605; G06T 2207/10016; G06T 2207/30228; A63B 67/187

(57) ABSTRACT

A method for automatically recognizing a sport court according to the present invention includes: a step for acquiring an original image of the sport court as captured by a camera; a step for converting the acquired original image and generating a binarized image; a step for detecting lines forming the court from the binarized image; a step for adding virtual extension lines to the detected lines to compensate for missing lines, to thereby generate preliminary court lines; a step for comparing a pre-stored regulation size sport court template and the preliminary court lines; a step for correcting the preliminary court lines according to the comparison result; a step for labeling the corrected court lines; and a step for generating sport court information including labeling information.

### FIELD

The present invention relates to a method and device for automatically recognizing a sports court, and more particularly, to a method and device for automatically recognizing a sports court and subsequently making an IN/OUT determination based on the automatically recognized court information.

### BACKGROUND

In sports events, there has always been a concern of misjudgment or biased judgment. Efforts have been made to overcome these concerns technically. According to a presentation by Martin School of Oxford University in the UK at the World Economic Forum in Davos, Switzerland in 2016, robots will replace sports referees within the next 10 years with a probability of 90% or more.

In particular, the application of video-assisted determination technology is expanding because the traditional ball games such as soccer, baseball, tennis, and badminton are very sensitive to referee decisions. Hawk-Eye, a tennis video reading system, was first introduced at the US Open, one of the world's four major tennis competitions in 2006, and FIFA started using a video reading system similar to Hawkeye at the Brazil World Cup in 2014.

Furthermore, aiming at the 2020 Tokyo Olympics, Japan has announced the introduction of a large-scale robot referee. The robot referee or automatic referee system is also a field of interest to many multinational companies.

In the automatic referee system, until now, the resolution of the camera has been increased and the number of cameras installed has been increased to increase the accuracy of the video reading. However, according to this development direction, since the number of installations will increase and the unit price of the camera will continue to increase, the total cost of development will drastically increase.

Moreover, it is difficult to install the above-mentioned expensive equipment and repeat the complicated installation process for each game in an amateur-level sports center, whereas judgment disputes are more frequent in amateur games than professional games. Therefore, there is high demand for an automatic judgment system that is inexpensive and portable.

Korean Registered Patent No. 10-17990747 discloses a system capable of playing a fair badminton game with a remote player using a court detection means and a shuttlecock detection means. In this disclosure, a tape-type detection sensor attached to the floor in the form of a badminton court or a light detection sensor such as infrared or laser was used as a court detection means. The shuttlecock detection means determines whether the shuttlecock has fallen inside or outside of the court area based on the predicted trajectory calculated using information on the direction, speed, and spin of the shuttlecock.

In order to recognize a sports court and make an IN/OUT call accordingly, it is the most efficient method to provide a mobile system that is simple to install or does not even require a separate installation, but such a method has not been suggested in the existing prior art.

### PROBLEM TO BE SOLVED

An object of the present invention is to provide a method and a device for automatically recognizing a sports court and making an IN/OUT determination which can prevent cost increases caused by an increasing number of installations and performance improvement of the camera required for video reading.

Another object of the present invention is to provide provide a method and a device for automatically recognizing a sports court and making an IN/OUT determination which is very easy to install and cost-effective.

### SUMMARY OF THE INVENTION

To achieve the above objects, the method and apparatus for automatically recognizing sports courts according to the present invention include the following aspects and any combination thereof.

One aspect of the present invention is a method for automatically recognizing a sports court comprising obtaining an original image of a sports court by photographing it using a camera, generating a binarized image by converting the obtained original image, detecting lines constituting the court from the binarized image, generating preliminary court lines by applying virtual extension lines to the detected lines to compensate for missing lines, labeling respective units of the preliminary court lines required for making IN/OUT calls, and generating sports court information including labeling information.

Another aspect of the present invention further comparing the preliminary court lines with a pre-stored regular-dimensioned or regular-sized sports court template; and modifying the preliminary court lines according to a result of the comparison.

Another aspect of the present invention is a method for automatically recognizing a sports court comprising obtaining an original image of a sports court by photographing it using a camera, generating a binarized image by converting the obtained original image, detecting lines constituting the court from the binarized image, generating preliminary court lines by applying virtual extension lines to the detected lines to compensate for missing lines, comparing the preliminary court lines with a pre-stored regular-dimensioned sports court template, modifying the preliminary court lines according to a result of the comparison, labeling respective units of the modified court lines required for making IN/OUT calls, and generating sports court information including labeling information.

Another aspect of the present invention is a method for automatically recognizing a sports court further comprising correcting image distortion according to a change of a position of the camera.

Another aspect of the present invention is a method for automatically recognizing a sports court further comprising obtaining real-time image information of the sports court using the camera, recognizing a location of a shuttlecock from the real-time image information using pre-stored shuttlecock templates of various orientations, determining that the shuttlecock has touched a ground when it is confirmed that the recognized location of the shuttlecock is the same in consecutive image frames of a specific length, and making an IN/OUT call by comparing the location of the shuttlecock determined to have touched the ground with the sports court information.

Another aspect of the present invention is a method for automatically recognizing a sports court further comprising expressing an IN/OUT call with sound.

Another aspect of the present invention is a method for automatically recognizing a sports court further comprising expressing an IN/OUT call with lighting.

One aspect of the present invention is a device for automatically recognizing a sports court comprising a photographing unit for obtaining an original image of a sports court using a camera, a binarized image generation unit for converting the obtained original image to generate a binarized image, a court line detection unit for detecting lines constituting the court from the binarized image, a preliminary court line generation unit for generating preliminary court lines by applying virtual extension lines to the detected lines to compensate for missing lines, a labeling unit for labeling respective units of the modified court lines required for making IN/OUT calls, and a sports court information generation unit for generating sports court information including labeling information.

Another aspect of the present invention further comprising a template comparison unit for comparing the preliminary court lines with a pre-stored regular-dimensioned sports court template, and a preliminary court line modification unit for correcting the preliminary court lines according to a result of the comparison.

Another aspect of the present invention is a device for automatically recognizing a sports court comprising a photographing unit for obtaining an original image of a sports court using a camera, a binarized image generation unit for converting the obtained original image to generate a binarized image, a court line detection unit for detecting lines constituting the court from the binarized image, a preliminary court line generation unit for generating preliminary court lines by applying virtual extension lines to the detected lines to compensate for missing lines, a template comparison unit for comparing the preliminary court lines with a pre-stored regular-dimensioned sports court template, a preliminary court line modification unit for correcting the preliminary court lines according to a result of the comparison, a labeling unit for labeling respective units of the modified court lines required for making IN/OUT calls, and a sports court information generation unit for generating sports court information including labeling information.

Another aspect of the present invention is a device for automatically recognizing a sports court further comprising a distortion correction unit for correcting image distortion according to a change of position of the camera.

Another aspect of the present invention is a device for automatically recognizing a sports court, wherein the photographing unit obtains real-time image information of the sports court using the camera, further comprising a shuttlecock recognition unit for recognizing a location of a shuttlecock from the real-time image information using pre-stored shuttlecock templates of various orientations, a shuttlecock landing determination unit for determining that the shuttlecock has touched a ground when it is confirmed that the recognized location of the shuttlecock is the same in consecutive image frames of a specific length, and an IN/OUT call unit for making an IN/OUT call by comparing the location of the shuttlecock determined to have touched the ground with the sports court information.

Another aspect of the present invention is a device for automatically recognizing a sports court further comprising a sound output unit for expressing an IN/OUT call by the IN/OUT call unit with sound.

Another aspect of the present invention is a device for automatically recognizing a sports court further comprising a light output unit for expressing an IN/OUT call by the IN/OUT call unit with lighting.

### EFFECT OF THE INVENTION

The automatic sports court recognition method and apparatus according to the present invention is simple to install, portable and cost-effective.

### BRIEF DESCRIPTION OF THE DRAWINGS

FIG. 1 illustrates components constituting a sports court automatic recognition device according to an embodiment of the present invention.

FIG. 2A is an image of a sports court captured by a photographing unit according to an embodiment of the present invention.

FIG. 2B shows a binarized image of the sports court image of FIG. 2A according to an embodiment of the present invention.

FIG. 2C shows that a court line is detected from the binarized image of FIG. 2B according to an embodiment of the present invention.

FIG. 2D shows a preliminary court line generated by applying virtual extension lines to the court line detected in FIG. 2C according to an embodiment of the present invention.

FIG. 3 shows labeling of the court line according to an embodiment of the present invention.

FIG. 4A shows, as an example of a sports court, the overall dimensions of a badminton court.

FIGS. 4B to 4D illustrate, as an example of sports courts, in-out judgment lines for badminton matches of singles, doubles, and serves, respectively.

FIG. 5 shows an example of a shuttlecock template having various postures.

FIG. 6 is a flowchart of a method for automatically recognizing a sports court according to an embodiment of the present invention.

### DETAILED DESCRIPTION OF THE PRESENT EMBODIMENTS

Hereinafter, embodiments of a method and apparatus for automatically recognizing sports courts and determining IN/OUT according to the present invention will be described in detail with reference to the accompanying drawings.

Terms such as ‘˜unit’, ‘˜block’, and ‘˜module’ used throughout this specification may mean a unit that processes at least one function or operation. For example, it can mean software components, or hardware components such as FPGAs or ASICs. However, ‘˜unit’, ‘˜block’, and ‘˜module’ are not limited to software or hardware. The ‘˜unit’, ‘˜block’, and ‘˜module’ may be configured to be in an addressable storage medium or may be configured to reproduce one or more processors. Thus, as an example, ‘˜unit’, ‘˜block’, and ‘˜module’ include components such as software components, object-oriented software components, class components and task components, processes, functions, properties, procedures, algorithms, subroutines, segments of a program code, drivers, firmware, microcode, circuits, data, database, data structures, tables, arrays and variables. Components and functions provided in ‘˜unit’, ‘˜block’, and ‘˜module’ can be combined into a smaller number of elements and ‘˜unit’, ‘˜block’, and ‘˜module’ and can be further divided into ‘˜unit’, ‘˜block’, and ‘˜module’ with additional components.

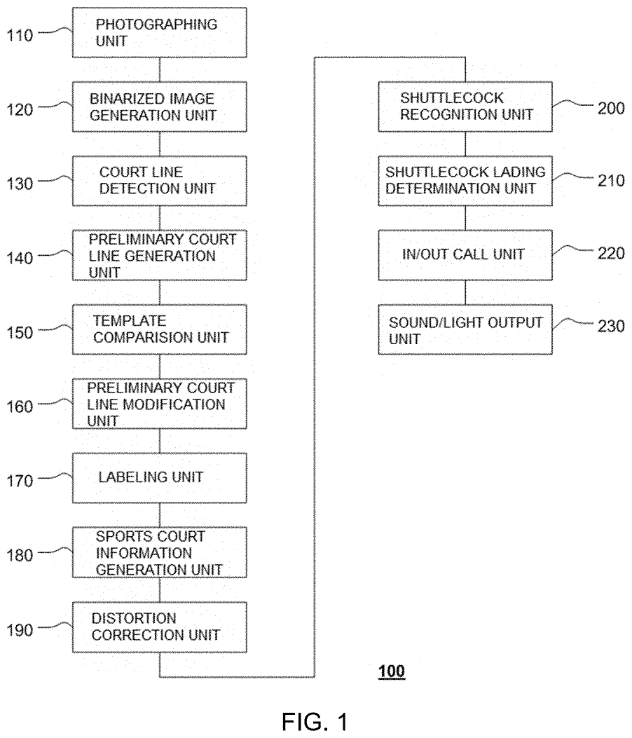

FIG. 1 is a configuration of a device 100 for automatically recognizing a sports court according to an embodiment of the present invention. First, as a configuration for automatically recognizing a sports court, a photographing unit 110, a binarized image generating unit 120, a court line detection unit 130, a preliminary court line generation unit 140, a template comparison unit 150, a preliminary court line modification unit 160, a labeling unit 170, and a sports court information generation unit 180 may be included. A distortion correction unit 190 may be further included.

In addition, as a configuration for determining in/out of a ball used for a corresponding sport, for example, a shuttlecock using the automatically recognized sports court information, a shuttlecock recognition unit 200, a shuttlecock landing determination unit 210, and an in/out call unit 220 may be included. A sound/light output unit 230 may be further included.

The photographing unit 110 generally includes a camera, but may be any type of camera module capable of instantaneously capturing or taking a video of an image of a sports court. For example, a CMOS (Complementary Metal Oxide Semiconductor) camera module, or a CCD (Charge-Coupled Device) camera module, which are a visible light camera module, may be used. Particularly, a camera module suitable for capturing an image of an indoor sports court is desirable.

The binarized image generating unit 120 converts the image generated by the photographing unit 110 into a binarized image. The binarized image generating unit 120 may perform binarization of the original image captured by the photographing unit 110 to generate a binarized image in which the court line candidate region appears white and other background region appears black.

As the binarization processing method, any method suitable for detecting a court line, for example, an Otsu Threshold method may be used.

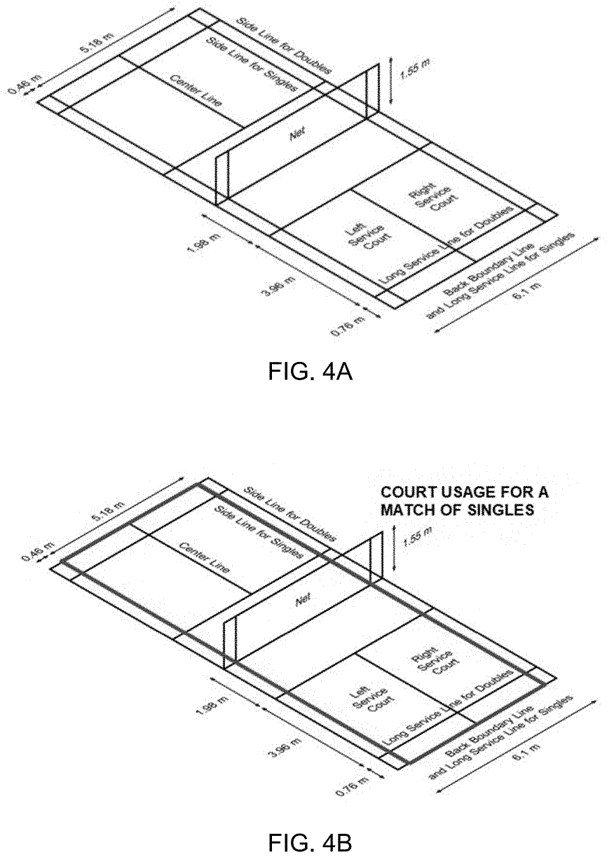

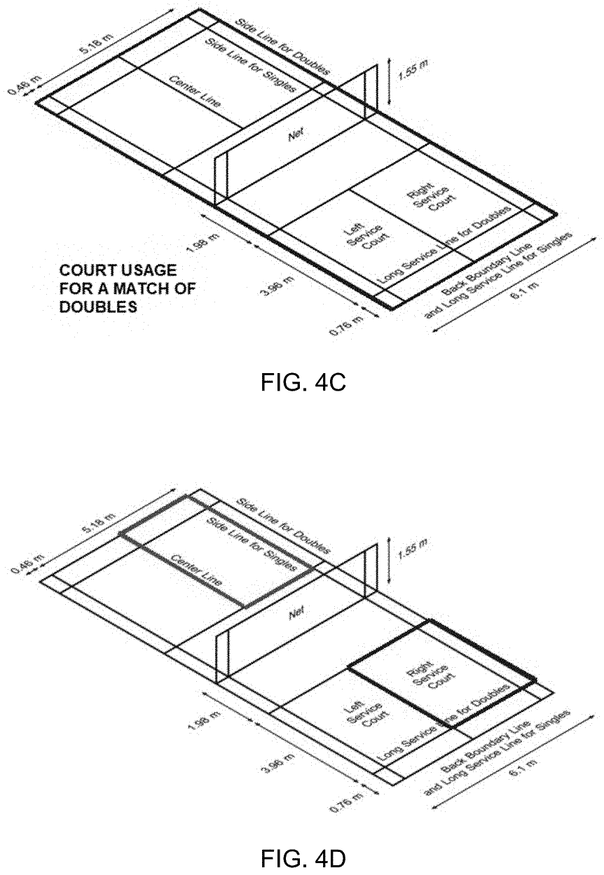

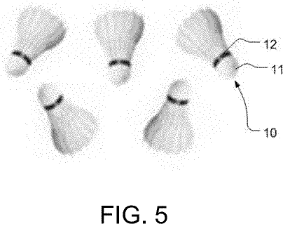

The court line detection unit 130 detects a court line from the binarized image generated by the binarized image generating unit 120. In the binarized image, in addition to the court line candidate area, some background areas may appear white depending on surrounding lighting conditions, for example, reflection of lighting installed in an indoor gymnasium, or influence of sunlight through windows. In addition, white objects placed around the court, such as net poles or rackets, may also appear white as a result of binarization. Therefore, it is necessary to detect only the court line in the white area of the binarized image. Since the standard of the sports court is known immutable information (refer to FIG. 4A), only a portion of the white region that matches the immutable court information can be extracted as a court line using an image processing algorithm.

The preliminary court line generation unit 140 generates a preliminary court line by adding virtual extension lines to the court line detected by the court line detection unit 130. The original image of the sports court obtained by the photographing unit 110 may not obtain an image of the entire court according to various conditions such as a photographing position, a field of view (FOV), or light reflection. Especially when using a single camera, such possibilities are significant. In addition, when a part of the line is torn or erased due to aging, the entire court line cannot be detected.

In order to compensate for the undetected court line, virtual extension lines can be applied to the court line detected by the court line detection unit 130. A sports court line usually consists of about 10 straight lines. Even if all of the straight lines are detected, a virtual extension line as described above is particularly useful when a portion of an individual straight line is not detected. The court line to which the virtual line is applied is created as a preliminary court line.

The template comparison unit 150 compares the preliminary court line with a pre-input regular court model. As a regular court model, a desired model from regular court models in various sports events can be selected in advance. According to the comparison result, it may be determined whether there is a missing line or an erroneously recognized line in the preliminary court line.

The preliminary court line modification unit 160 may modify the preliminary court line using the comparison result information by the template comparison unit 150. For example, if it is determined that there is a missing line, it may be filled in. Particularly, when the court line detected by the court line detection unit 130 does not entirely detect some of the straight lines constituting the corresponding sports court line, the preliminary court line modification unit 160 may compensate for the missing lines. In addition, it is also possible to delete a part that is erroneously recognized as a court line, such as a part where a white bar around the court is recognized as a line.

The labeling unit 170 classifies and labels the court line modified by the preliminary court line modification unit 160 by the units required for in/out determination. Referring to FIGS. 4B to 4D, lines involved in in/out determination may vary according to a specific situation such as a game mode like singles or doubles, or a serve situation, and thus appropriate units (refer to FIGS. 4B to 4D) may be labeled as necessary. Since the modified court line represents an already completed court, after matching it to each line group for IN/OUT determination previously input, pixels corresponding to the group may be separated and labeled.

Alternatively, it may be possible to separate and label pixel information distributed at a certain distance from the camera by using the positional relationship information with the camera capturing the court image.

The sports court information generation unit 180 generates one completed sports court information, including the labeling information collected through the labeling unit 170.

In addition, it may be possible to include a verification unit (not shown) for verifying the generated sports court information. For example, verification may be performed by comparing the number of contact points (i.e., known information) in which two or more straight lines meet on a regular sports court template and the number of contact points (i.e., corresponding information) on the generated sports court information. The verification may be performed after modification is made by the preliminary court line modification unit 160.

When the position of the camera is changed after the sports court information is generated, the distortion correction unit 190 corrects the existing sports court information. Specifically, if a change in the position of the camera is confirmed by repeatedly performing at least a part of the above-described court line recognition process at a regular time interval, necessary correction may be performed on the existing sports court information. For example, by comparing the absolute or relative positions of specific element pixels constituting the detected court line, such as pixels forming both corners of the court after sequentially executing the photographing unit 110, the binarized image generating unit 120, and the court line detection unit 130, it may be possible to determine whether the camera position has been changed. The information on the element pixel may be stored separately when the existing sports court information is generated so that the comparison executed later by the distortion correction unit 190 may be facilitated.

According to the determination of the degree of distortion by the distortion correction unit 190, the existing court information may be used as it is, the existing court information may be finely displaced, or new court information may be generated.

The shuttlecock recognition unit 200 recognizes the position of the shuttlecock from the video information acquired by the photographing unit 110. Since the shuttlecock is not spherical but has a shape symmetrical to one axis, it can be recognized in various shapes, postures, or orientation during a game. Accordingly, the position of the shuttlecock may be recognized through comparison with a template (refer to FIG. 5) of a shuttlecock having various orientations and postures previously stored. Alternatively, it will be possible to recognize the position of the shuttlecock by using the fact that the speed of the shuttlecock is the fastest in the video. Of course, it will be possible to recognize balls other than the shuttlecock depending on the event.

The shuttlecock landing determination unit 210 may determine landing of the shuttlecock by confirming whether or not the recognized shuttlecock is at the same position in consecutive image frames of a specific length.

The shuttlecock landing determination unit 210 continues to run during a game. At the moment the shuttlecock lands on the court during a game, it will be at the same position in the video frames before and after. Thus, it is possible to determine whether the shuttlecock has landed by comparing the positions of the shuttlecocks within the video frames before and after. Accordingly, the length of each video frame to be compared may be determined as an optimal length for determining whether to land or not in consideration of the speed of the ball in the corresponding event and the number of frames per second, etc. According to the comparison result, if it is confirmed that the shuttlecock is at the same position in the consecutive image frames of the specific length, it may be determined that the shuttlecock has touched the floor.

Additionally, color information of the black band portion 12 of the shuttlecock 10 may be used to more accurately determine whether the shuttlecock lands or not (see FIG. 5). The sports court template and the shuttlecock template may basically include color information. The ball part 11 of the shuttlecock 10 has white color information and the band part 12 has black color information. Since the shuttlecock is white in overall, there may be a problem in recognition of it during landing if it overlaps the court line which is also white. Such problem can be solved by utilizing the characteristics of the shuttlecock, that the ball part 11 is white and the band part 12 is black, as an auxiliary template information. Likewise, since, for example, a yellow tennis ball is completely distinguished from the line color, it will be possible to determine the landing using only the color information of the ball.

The in/out determining unit 220 may compare the position information of the shuttlecock determined to have landed with the sports court information automatically recognized previously to determine whether the shuttlecock is inside or outside the line, that is, IN/OUT. As described above, using the labeling information for each court line created by the labeling unit 170 may be programmed to enable an IN/OUT determination suitable for the corresponding game situation.

The sound/lighting output unit 230 may generate a preset sound or turn on/off the lighting according to the determination of the in/out determination unit 220. For example, it is possible to play a sound, “in” or green light flashing for the inside, or play the sound, “out” or red light flashing for the outside.

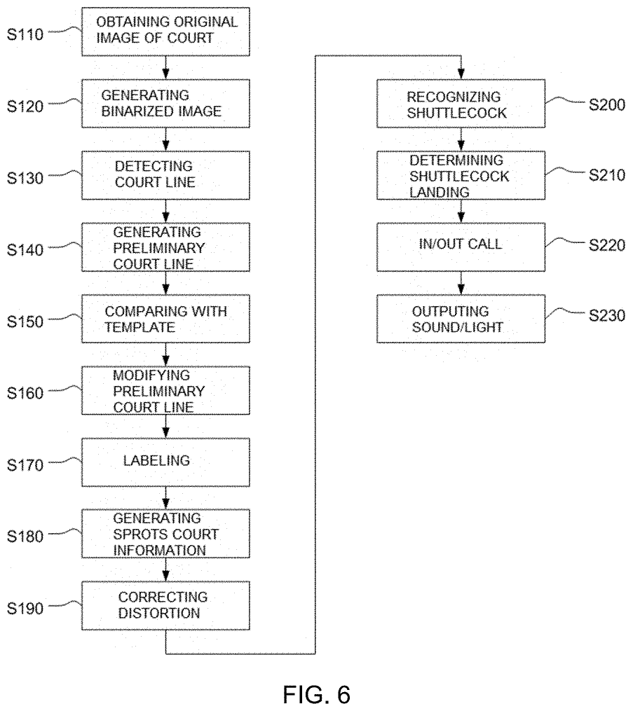

FIG. 6 is a flowchart illustrating a method for automatically recognizing a sports court according to an embodiment of the present invention.

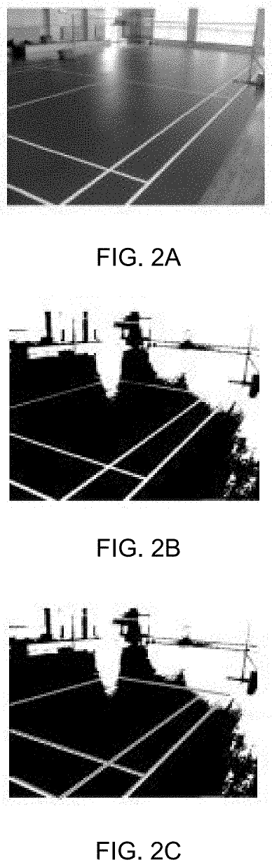

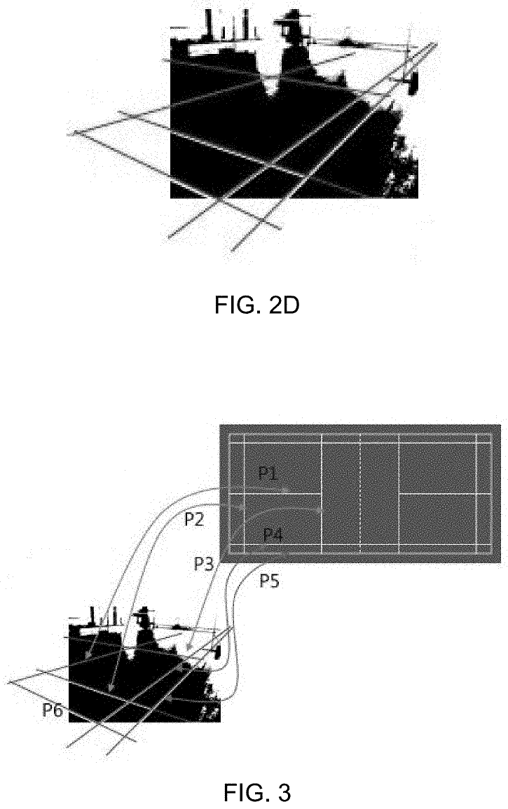

First, the entire sports court is photographed using a camera (S110). It is preferable to set the distance of the camera from the court, the height of the camera, the shooting angle, etc. so that the image of the sports court (see FIG. 2A) can be maximally captured. Of course, it may be possible to guide the optimal position of the camera in advance according to the characteristics of the camera. In addition, a criterion for the quality of the original image may be set in advance so that another original image can be obtained when the state of the acquired original image is insufficient for subsequent processing.

Subsequently, a binarized image is generated from the original court image (S120). It is most preferable that only the court line appears white after the binarization treatment, however, depending on the shooting conditions such as light reflection or the presence of foreign substances around the court, parts other than the court line may also appear as white areas in the binarized image (see FIG. 2B).

Then, a court line is extracted from the binarized image (S130). In order to extract only the court line from the white area including substances other than the court line, as described above, a template of a regular sports court, which is unchangeable information, can be used (see FIG. 2C). Depending on the type of court, the corresponding court information can be set in advance or selected during execution.

Next, a preliminary court line is generated from the extracted court line (S140). This can be achieved by extending virtual lines to the court line detected in the court line detection step S130 (see FIG. 2D). By doing so, when an image of the entire court is not obtained in the first place or a part of the actual court line is lost, the undetected court line can be supplemented. In this way, the court line to which the virtual line is applied can be created as a preliminary court line.

Next, the pre-input regular court template and the preliminary court line are compared (S150). The regular court template can be set in advance or selected during execution from the pre-stored regular court templates of various sports. According to the comparison result, it is determined whether there is a missing line in the preliminary court line or whether there is an erroneously recognized line, and if necessary, the preliminary court line can be modified (S160).

Thereafter, labeling is performed on the modified preliminary court line (S170). The labeling is performed for each unit required for in/out determination according to the sports event.

Such labeling may be completed automatically according to a pre-programmed algorithm, but a separate display unit may be provided to show the labeling result, and the labeling may be modified and confirmed by the user using an external input device or a touch screen. It is obvious that such user intervention will be possible at any stage before or after this stage.

Referring to FIG. 3, it is shown that the modified preliminary court line is matched with each line on the template and labeled as P1, P2, P3, P4, P5, P6. etc. as necessary. Thereafter, automatic recognition of the sports court can be completed by generating sports court information including labeling information (S180).

After the automatic recognition of the sports court is made, the position of the camera may change due to an external force or the like. In preparation for this case, it is possible to periodically perform distortion correction (S190) according to an embodiment of the present invention.

A method of recognizing the shuttlecock using the sports court information for which automatic recognition has been completed is as follows.

First, while the camera used to obtain the sports court information is maintained at the same position, video information of a game played within the same angle is obtained, and the position of the shuttlecock is recognized from the obtained video information (S200). The recognition of the shuttlecock can be achieved through comparison with the previously stored shuttlecock template.

In this way, the position of the shuttlecock is recognized in real time, and it is determined whether the shuttlecock has landed by comparing consecutive image frames of a specific length (S210). That is, pixels recognized as the shuttlecock are compared between the front and rear frames, and if there is no change in the pixels constituting the shuttlecock, it may be determined that the shuttlecock has landed. The determination of whether the shuttlecock landed or not can be continuously executed during the game.

When it is determined that the shuttlecock landed, in/out call is executed (S220). By comparing the location information of the landed shuttlecock with information on the sports court including labeling information, it is possible to determine whether the shuttlecock has fallen inside or outside the line.

Thereafter, according to an IN/OUT determination, a preset sound may be played or the lighting may be turned on and off (S230).

The embodiments according to the present invention described above can be implemented by an information processing device in which software and hardware are combined, further implemented in the form of program instructions that can be executed through various computer components, and recorded in a computer-readable recording medium. The computer-readable recording medium may include program instructions, data files, data structures, etc. alone or in combination. The program instructions recorded in the computer-readable recording medium may be specially designed and configured for the present invention, or may be known and usable to those skilled in the computer software field. Examples of computer-readable recording media include magnetic media such as hard disks, floppy disks, and magnetic tapes, optical recording media such as CD-ROMs and DVDs, magneto-optical media such as floptical disks, and hardware devices specifically configured to store and execute program instructions such as ROM, RAM, flash memory, and the like. Examples of the program instructions include not only machine language codes such as those produced by a compiler, but also high-level language codes that can be executed by a computer using an interpreter or the like. The hardware device may be configured to operate as one or more software modules to perform processing according to the present invention, and vice versa.

As described above, a method and device for automatically recognizing a court and determining IN/OUT according to embodiments of the present invention have been described. However, the present invention is not limited to the above-described embodiments, and various modifications and altered implementation may be applied by a person skilled in the technical field belonging to the present invention without departing from the spirit of the present invention claimed in the claims.

-Explanation of the reference numerals-

100: sports court automatic recognition device
110: photographing unit
120: binarized image generation unit
130: court line detection unit
140: preliminary court line generation unit
150: template comparison unit
160: preliminary court line modification unit
170: labeling unit
180: sports court information generation unit
190: distortion correction unit
200: shuttlecock recognition unit
210: shuttlecock landing determination unit
220: in/out determination unit
230: sound/light output unit

What is claimed is:

1. A method for automatically recognizing a sports court, comprising:
obtaining an original image of a sports court by photographing it using a camera;
generating a binarized image by converting the obtained original image;
detecting lines constituting the court from the binarized image;
generating preliminary court lines by applying virtual extension lines to the detected lines to compensate for missing lines;
comparing the preliminary court lines with a pre-stored regular-sized sports court template;
modifying the preliminary court lines according to a result of the comparison;
labeling respective units of the modified court lines required for making IN/OUT calls; and
generating sports court information including labeling information.

2. The method of claim 1, further comprising:
correcting image distortion according to a change of a position of the camera.

3. The method of claim 1 or 2, further comprising:
obtaining real-time image information of the sports court using the camera;
recognizing a location of a shuttlecock from the real-time image information using pre-stored shuttlecock templates of various orientations;
determining that the shuttlecock has touched a ground when it is confirmed that the recognized location of the shuttlecock is the same in consecutive image frames of a specific length; and
making an IN/OUT call by comparing the location of the shuttlecock determined to have touched the ground with the sports court information.

4. The method of claim 3, further comprising:
expressing an IN/OUT call with sound.

5. The method of claim 3, further comprising:
expressing an IN/OUT call with lighting.

6. A device for automatically recognizing a sports court, comprising:
a photographing unit for obtaining an original image of a sports court using a camera;
a binarized image generation unit for converting the obtained original image to generate a binarized image;
a court line detection unit for detecting lines constituting the court from the binarized image;
a preliminary court line generation unit for generating preliminary court lines by applying virtual extension lines to the detected lines to compensate for missing lines;
a template comparison unit for comparing the preliminary court lines with a pre-stored regular-sized sports court template;
a preliminary court line modification unit for correcting the preliminary court lines according to a result of the comparison;
a labeling unit for labeling respective units of the modified court lines required for making IN/OUT calls; and
a sports court information generation unit for generating sports court information including labeling information.

7. The device of claim 6, further comprising:
a distortion correction unit for correcting image distortion according to a change of position of the camera.

8. The device of claim 6 or 7, wherein the photographing unit obtains real-time image information of the sports court using the camera, and the device further comprising:
a shuttlecock recognition unit for recognizing a location of a shuttlecock from the real-time image information using pre-stored shuttlecock templates of various orientations;
a shuttlecock landing determination unit for determining that the shuttlecock has touched a ground when it is confirmed that the recognized location of the shuttlecock is the same in consecutive image frames of a specific length; and
an IN/OUT call unit for making an IN/OUT call by comparing the location of the shuttlecock determined to have touched the ground with the sports court information.

9. The device of claim 8, further comprising:
a sound output unit for expressing an IN/OUT call by the IN/OUT call unit with sound.

10. The device of claim 8, further comprising:
a light output unit for expressing an IN/OUT call by the IN/OUT call unit with lighting.
